(19) United States
(12) Patent Application Publication
(10) Pub. No.: US 2026/0197596 A1
(43) Pub. Date: Jul. 9, 2026

(54) MICROPHONE ARRAY CALIBRATION METHOD AND APPARATUS, TELEPHONE HEADSET, STORAGE MEDIUM, AND COMPUTER PROGRAM PRODUCT

(71) Applicant: MERRY ELECTRONICS (SHENZHEN) CO., LTD., ShenZhen (CN)

(72) Inventors: Tianliang ZHANG, ShenZhen (CN); Huaze YANG, ShenZhen (CN); Hao ZHANG, ShenZhen (CN)

(21) Appl. No.: 19/094,099

(22) Filed: Mar. 28, 2025

(30) Foreign Application Priority Data
Jan. 3, 2025 (CN) 202510009624.8

(51) Int. Cl. H04R 29/00; H04R 1/08; H04R 1/10; H04R 1/40; H04R 3/00

(52) U.S. Cl. CPC H04R 29/005; H04R 1/08; H04R 1/1008; H04R 1/406; H04R 3/005; H04R 2201/107

(57) ABSTRACT

Microphone array calibration method and apparatus, a telephone headset, a storage medium and a computer program product are provided. The method includes: when detecting that a position at which a microphone boom is located is deflected relative to pre-configured reference position, determining target distance between each microphone in a microphone array and a mouth, the microphone array being configured to collect a sound from the mouth and installed in the microphone boom; in a case where the microphone boom is located at the reference position, obtaining reference distance between each microphone and the mouth and reference value for calibration parameter used for calibrating each microphone; determining target value for calibration parameter corresponding to each microphone based on a difference between the target distance and the reference distance and the reference value; and calibrating the microphone array based on target value for calibration parameter corresponding to each microphone.

### CROSS-REFERENCE TO RELATED APPLICATION

This application claims priority to Chinese Patent Application No. 202510009624.8, filed with CNIPA on Jan. 3, 2025, entitled as “MICROPHONE ARRAY CALIBRATION METHOD AND APPARATUS, TELEPHONE HEADSET, STORAGE MEDIUM, AND PRODUCT”, the entire contents of which are incorporated herein by reference.

### TECHNICAL FIELD

The present application relates to the field of microphone calibration technologies, and in particular, to a microphone array calibration method, a microphone array calibration apparatus, a telephone headset, a storage medium, and a computer program product.

### BACKGROUND

The telephone headset may be connected to an electronic device, and two-way voice calls can be implemented based on communications technologies. The telephone headset may collect sounds by using a microphone array disposed in a microphone boom. The microphone array includes multiple microphones. The microphone array may enhance sound signals from a position of a sound source by using directional beams pointing at the position of the sound source from the multiple microphones, thereby suppressing noises and interference. When a relative position between the sound source and the microphone array changes, the microphone array needs to be calibrated to optimize noise reduction performance of the microphone array. Generally, each microphone is calibrated according to a reference value for a calibration parameter corresponding to the each microphone. The reference values for the calibration parameters are set on a precondition that the microphone boom is located at an ideal reference position.

However, during the actual usage of the telephone headset by a user, the manner of calibrating the microphones according to the reference values for the calibration parameters may result in unsatisfactory quality of sounds collected by the microphone array.

### SUMMARY

In view of the above technical problem, there is a need to provide a microphone array calibration method, a microphone array calibration apparatus, a telephone headset, a storage medium, and a computer program product, which can improve the quality of collected sounds.

In a first aspect, the present application provides a microphone array calibration method, including:
in a case of detecting that a position at which a microphone boom of a telephone headset is l ocated is deflected relative to a pre-configured reference position, determining a target distance between each microphone in a microphone array of the telephone headset and a mouth, where the microphone array is configured to collect a sound from the mouth and is installed in the microphone boom;
obtaining a reference distance between each microphone and the mouth in a case where the microphone boom is located at the reference position, and obtaining a reference value for a calibration parameter used for calibrating the each microphone in the case where the microphone boom is located at the reference position;
determining a target value for the calibration parameter corresponding to each microphone based on a difference between the target distance and the reference distance and the reference value for the calibration parameter; and
calibrating the microphone array based on the target value for the calibration parameter corresponding to the each microphone.

In a second aspect, the present application further provides a microphone array calibration apparatus, including:
a distance determination module, configured to: in a case of detecting that a position at which a microphone boom of a telephone headset is located is deflected relative to a pre-configured reference position, determine a target distance between each microphone in a microphone array of the telephone headset and a mouth, where the microphone array is configured to collect a sound from the mouth and is installed in the microphone boom;
an obtaining module, configured to: obtain a reference distance between each microphone and the mouth in a case where the microphone boom is located at the reference position, and obtain a reference value for a calibration parameter used for calibrating the each microphone in the case where the microphone boom is located at the reference position; and
a calibration module, configured to: determine, based on a difference between the target distance and the reference distance and the reference value for the calibration parameter, a target value for the calibration parameter corresponding to each microphone; and calibrate the microphone array based on the target value for the calibration parameter corresponding to the each microphone.

In a third aspect, the present application also provides a telephone headset, which includes a headset body and a microphone boom, and further includes a memory and a processor provided in the headset body, and a microphone array provided in the microphone boom. The memory stores a computer program. The microphone array is configured to collect a sound. The processor, when executing the computer program, performs: in a case of detecting that a position at which the microphone boom of the telephone headset is located is deflected relative to a pre-configured reference position, determining a target distance between each microphone in the microphone array of the telephone headset and a mouth, where the microphone array is configured to collect a sound from the mouth and is installed in the microphone boom; obtaining a reference distance between each microphone and the mouth in a case where the microphone boom is located at the reference position, and obtaining a reference value for a calibration parameter used for calibrating the each microphone in the case where the microphone boom is located at the reference position; determining a target value for the calibration parameter corresponding to each microphone based on a difference between the target distance and the reference distance and the reference value for the calibration parameter; and calibrating the microphone array based on the target value for the calibration parameter corresponding to the each microphone.

In a fourth aspect, the present application further provides a computer-readable storage medium which stores a computer program thereon, and the computer program, when being executed by a processor, cause the processor to implement:
in a case of detecting that a position at which a microphone boom of a telephone headset is located is deflected relative to a pre-configured reference position, determining a target distance between each microphone in a microphone array of the telephone headset and a mouth, where the microphone array is configured to collect a sound from the mouth and is installed in the microphone boom;
obtaining a reference distance between each microphone and the mouth in a case where the microphone boom is located at the reference position, and obtaining a reference value for a calibration parameter used for calibrating the each microphone in the case where the microphone boom is located at the reference position;
determining a target value for the calibration parameter corresponding to each microphone based on a difference between the target distance and the reference distance and the reference value for the calibration parameter; and
calibrating the microphone array based on the target value for the calibration parameter corresponding to the each microphone.

In a fifth aspect, the present application further provides a computer program product, including a computer program, and the computer program, when being executed by a processor, cause the processor to implement:
in a case of detecting that a position at which a microphone boom of a telephone headset is located is deflected relative to a pre-configured reference position, determining a target distance between each microphone in a microphone array of the telephone headset and a mouth, where the microphone array is configured to collect a sound from the mouth and is installed in the microphone boom;
obtaining a reference distance between each microphone and the mouth in a case where the microphone boom is located at the reference position, and obtaining a reference value for a calibration parameter used for calibrating the each microphone in the case where the microphone boom is located at the reference position;
determining a target value for the calibration parameter corresponding to each microphone based on a difference between the target distance and the reference distance and the reference value for the calibration parameter; and
calibrating the microphone array based on the target value for the calibration parameter corresponding to the each microphone.

In the aforementioned microphone array calibration method and apparatus, the telephone headset, the storage medium and the computer program product, in a case of detecting that the position at which the microphone boom of the telephone headset is located is deflected relative to the pre-configured reference position, the target distance between each microphone in the microphone array and the mouth can be determined automatically. Then, the target value for the calibration parameter is determined based on the difference between the target distance and the reference distance and the reference value for the calibration parameter, and the microphone is calibrated according to the target value for the calibration parameter. In this way, in the case where the position at which the microphone boom is located is deflected relative to the reference position, the target value for the calibration parameter can be accurately determined based on the difference between the target distance and the reference distance from the microphone to the mouth. Since the microphone is calibrated based on the target value for the calibration parameter instead of the reference value for the calibration parameter, each microphone in the microphone array can be accurately calibrated in accordance with the position where the microphone boom is located. Therefore, quality of sounds collected by the telephone headset can be improved.

### BRIEF DESCRIPTION OF THE DRAWINGS

To further clarify technical solutions according to embodiments of the present application, drawings to be used in descriptions of the embodiments of the present application are briefly introduced hereinafter. It is obvious that these drawings described as follows are only for some of the embodiments of the present application, while other related drawings can be obtained by those of ordinary skill in the art based on these drawings without paying creative efforts.

FIG. 1 is a schematic flowchart of a microphone array calibration method according to an embodiment;

FIG. 2 is a schematic diagram of an example that a headset body is worn over a human head according to an embodiment;

FIG. 3 is a schematic diagram exemplarily showing respective vectors when a headset body is worn over a human head according to an embodiment;

FIG. 4 is a schematic diagram showing various position points when a headset body is worn over a human head according to an embodiment;

FIG. 5 is a schematic diagram exemplarily showing a first vector and respective position points in a three-dimensional rectangular coordinate system according to an embodiment;

FIG. 6 is a schematic flowchart of steps of microphone array calibration according to an embodiment;

FIG. 7 is a structural block diagram of a microphone array calibration apparatus according to an embodiment; and

FIG. 8 is a diagram of an internal structure of a telephone headset according to an embodiment.

### DETAILED DESCRIPTION OF THE EMBODIMENTS

To make the objectives, technical solutions and advantages of the present application clearer and more understandable, the present application is further detailed hereinafter according to embodiments in conjunction with the drawings. It is understandable that specific embodiments described herein are merely for the purpose of explaining the present application rather than limiting the present application.

As shown in FIG. 1, a microphone array calibration method is provided in an exemplary embodiment. In the embodiment, it is illustrated by way of an example that the method is applied to a telephone headset. According to the embodiment, the method includes the following steps.

In step 102, in a case of detecting that a position at which a microphone boom of the telephone headset is located is deflected relative to a pre-configured reference position, a target distance between each microphone in a microphone array of the telephone headset and a mouth is determined, where the microphone array is utilized to collect a sound from the mouth and is installed in the microphone boom.

The telephone headset may be connected to an electronic device having communication function and thus may be utilized to perform voice calls. The electronic device having communication function may be a telephone, a personal computer, a laptop, a smartphone, a tablet, or other. In some scenarios, the telephone headset may also be referred to as a telephone communication headset, a telephonist-dedicated headset, a call center headset, or other.

The telephone headset may include a headset body and the microphone boom. The headset body may be in over-the-head type or supra-aural type. The headset body may include an earbuff and a headband. A speaker for audio playing may be disposed in the earbuff. The headband is connected to the earbuff, and is utilized to fix the headset body onto the head of a human. A controller may be disposed in the headset body. The controller may be specifically disposed in the earbuff. The controller may be utilized to execute the microphone array calibration method. The microphone array calibration method may be applied to a scenario in which the headset body is in a worn state, or may be applied to a scenario in which the headset body is in a non-worn state.

The microphone boom is utilized to install the microphone array. The microphone array may include multiple microphones. Specifically, the microphone array may include three microphones or more than three microphones. In some scenarios, the microphone may be referred to as Mic, and the microphone boom may be referred to as Mic Boom. The microphone boom may be rotatably connected to the headset body at a position of a headphone-microphone connection. The headphone-microphone connection may be located in the earbuff of the headset body. The pre-configured reference position may indicate a standard position that is pre-configured for the microphone boom in a case that the headset body is in the worn state. The pre-configured reference position may be a position of the microphone boom at which an angle between the microphone boom and the headset body is a preset angle. The preset angle is, for example, 120 degrees, 130 degrees, or other.

For example, the telephone headset may include a distance detection module. In a case of detecting that a position at which the microphone boom of the telephone headset is located is deflected relative to the pre-configured reference position, the controller of the telephone headset may detect, by using the distance detection module, a target distance between each microphone in the microphone array of the telephone headset and the mouth, the microphone array being utilized to collect a sound from the mouth. The distance detection module may be implemented by using an infrared sensor, an optoelectronic sensor, an ultrasonic sensor, an image sensor, or other components.

In an embodiment, the controller of the telephone headset may detect the angle between the microphone boom and the headset body. In a case where an angle difference between the angle between the microphone boom and the headset body and the preset angle is greater than a preset angle difference, it is determined that the position at which the microphone boom of the telephone headset is located is detected to be deflected relative to the pre-configured reference position. The preset angle difference is 1 degree, 2 degrees, 3 degrees, or others. The angle between the microphone boom and the headset body may be detected by using an angle measurement mechanism. The angle measurement mechanism may be an angle sensor or a sliding rheostat. In a case where the sliding rheostat is utilized as the angle measurement mechanism, the sliding rheostat may be connected to the headphone-microphone connection. The headphone-microphone connection may be a rotatable mechanism, and may change when the microphone boom rotates relative to the headset body; consequently, a value of the resistance of the sliding rheostat changes. Different values of the resistance of the sliding rheostat correspond to different angles. Therefore, by detecting a current value of the resistance of the sliding rheostat, the angle between the microphone boom and the headset body can be determined.

In an embodiment, the controller of the telephone headset may determine a preset relative position of the mouth relative to the headphone-microphone connection, and determine the target distance between the microphone and the mouth based on a target relative position of the microphone relative to the headphone-microphone connection and the preset relative position.

The preset relative position may be set with reference to a tangible head model wearing the headset body (the tangible head model is utilized to simulate a human head). For example, a relative position of a mouth of the tangible head model relative to the headphone-microphone connection in the headset body worn over the tangible head model may be taken as the preset relative position. Alternatively, the preset relative position may be set with reference to different human heads wearing the headset body. For example, an average relative position of relative positions of mouths of different human heads relative to the headphone-microphone connection in the headset body respectively worn over the different human heads may be determined as the preset relative position. The preset relative position may be represented by a relative distance and a relative azimuth angle that are of the mouth relative to the headphone-microphone connection in the real world three-dimensional space. Alternatively, both the mouth and the headphone-microphone connection can be indicated as position points in a coordinate system, and then the preset relative position may be represented by relative coordinates of the position point indicating the mouth relative to the position point indicating the headphone-microphone connection in the coordinate system. The target relative position may be represented in a way similar to that for representing the preset relative position. Specifically, the way for representing the target relative position can be obtained by replacing the mouth with the microphone in the foregoing description of the way for representing the preset relative position.

In step 104, a reference distance between each microphone and the mouth in a case where the microphone boom is located at the reference position is obtained, and a reference value for a calibration parameter used for calibrating the each microphone in the case where the microphone boom is located at the reference position is obtained.

The reference distance is a distance between each microphone and the mouth in the case where the microphone boom is located at the reference position. The reference value for the calibration parameter can be set according to engineering experience, or can be obtained through debugging in the case that the microphone boom is located at the reference position. The calibration parameter may include at least one of sensitivity or phase, or may include any other parameter. The sensitivity may represent a capability of the microphone to convert a sound signal into an electrical signal. The higher the sensitivity, the stronger the capability of the microphone in capturing the sound signal. The phase may represent phase differences between a sound signal received by the microphone and sound signals received by other microphones in the microphone array. Since different microphones in the microphone array are located at different positions relative to a sound source, a sound generated from the sound source may arrive at different microphones at different moments. Accordingly, there may exist differences in phases of sound signals respectively received by the different microphones.

For example, the controller of the telephone headset may obtain a reference distance pre-stored for the microphone and a reference value for the calibration parameter pre-stored for the microphone.

The reference distance may be detected in advance by the above-mentioned distance detection module. Specifically, in a case where the headset body is worn over the above-mentioned tangible head model and the microphone boom is located at the reference position, the distance detection module detects a distance between each microphone and the mouth to obtain the reference distance. Alternatively, in a case where the headset body is worn over different human heads and the microphone boom is located at the reference position, the distance detection module detects distances between each microphone and mouths of the different human heads, and an average of the distances between the each microphone and the mouths of the different human heads is calculated to obtain the reference distance.

The reference distance may be obtained by means of calculation in advance. Specifically, the preset relative position of the mouth relative to the headphone-microphone connection may be obtained. In the case where the microphone boom is located at the reference position, a reference relative position of each microphone relative to the headphone-microphone connection is determined. The reference distance between the each microphone and the mouth is determined based on the reference relative position and the preset relative position. The reference relative position is similar to the foregoing target relative position. They are different in that, the reference relative position is obtained in the case where the microphone boom is located at the reference position, while the target relative position is obtained in a case where the microphone boom is located at a current position. The current position at which the microphone boom is located refers to the position at which the microphone boom is located as described in step 102.

In step 106, based on a difference between the target distance and the reference distance and the reference value for the calibration parameter, a target value for the calibration parameter corresponding to each microphone is determined.

The difference between the target distance and the reference distance may be a difference value between the target distance and the reference distance, or may be a ratio of the target distance to the reference distance.

For example, the controller of the telephone headset may update the reference value for the calibration parameter based on the difference between the target distance and the reference distance, to obtain the target value for the calibration parameter corresponding to each microphone.

In an embodiment, the calibration parameter may include the sensitivity, and the reference value for the calibration parameter may include a reference value for the sensitivity. In the embodiment, the controller of the telephone headset may determine a change amount of the sensitivity based on the ratio of the target distance to the reference distance, and update the reference value for the sensitivity according to the change amount of the sensitivity to obtain a target value for the sensitivity.

In an embodiment, the calibration parameter may include the phase, and the reference value for the calibration parameter may include a reference value for the phase. In the embodiment, the controller of the telephone headset may determine a change amount of the phase based on the difference value between the target distance and the reference distance, and update the reference value for the phase according to the change amount of the phase to obtain a target value for the phase.

In an embodiment, the controller of the telephone headset may utilize at least one of the target value for the sensitivity or the target value for the phase as the target value for the calibration parameter corresponding to each microphone.

In step 108, the microphone array is calibrated based on the target value for the calibration parameter corresponding to each microphone.

For example, the controller of the telephone headset may calibrate a weight vector corresponding to each microphone based on the target value for the calibration parameter corresponding to the each microphone, to calibrate a main lobe direction of the microphone array.

The weight vector corresponding to one microphone may represent a contribution of a sound signal received by the microphone to a sound signal output by the microphone array. It may be understood that, according to the weight vectors of the different microphones in the microphone array, sound signals respectively received by the different microphones in the microphone array are weighted-superposed to form the sound signal output by the microphone array. The main lobe direction may represent a main direction range for sound reception of the microphone array, and may indicate a direction range within which the microphone array has strongest response to sound signals. By calibrating the weight vector corresponding to each microphone, the main lobe direction of the microphone array can direct to a valid sound source direction, for example, direct to the mouth of the human head wearing the headset body. Hence, the noise reduction effect is improved and the quality of collected sounds generated from the mouth is enhanced.

In an embodiment, the calibration parameter may include at least one of the sensitivity or the phase. The target value for the calibration parameter may include at least one of the target value for the sensitivity or the target value for the phase. In the embodiment, the controller of the telephone headset may utilize at least one of the target value for the sensitivity or the target value for the phase that are corresponding to each microphone as an input parameter of a Digital Signal Processing (DSP) algorithm, and calibrate, by using the DSP algorithm, the weight vector corresponding to each microphone to calibrate the main lobe direction of the microphone array.

In the aforementioned microphone array calibration method, in a case of detecting that the position at which the microphone boom of the telephone headset is located is deflected relative to the pre-configured reference position, the target distance between each microphone in the microphone array and the mouth can be determined automatically. Then, the target value for the calibration parameter is determined based on the difference between the target distance and the reference distance and the reference value for the calibration parameter, and the microphone is calibrated according to the target value for the calibration parameter. In this way, in the case where the position at which the microphone boom is located is deflected relative to the reference position, the target value for the calibration parameter can be accurately determined based on the difference between the target distance and the reference distance from the microphone to the mouth. Since the microphone is calibrated based on the target value for the calibration parameter instead of the reference value for the calibration parameter, each microphone in the microphone array can be accurately calibrated in accordance with the position where the microphone boom is located. Therefore, quality of sounds collected by the telephone headset can be improved.

In an exemplary embodiment, the microphone boom is rotatably connected to the headset body of the telephone headset at the position of the headphone-microphone connection. In a rotation plane formed by rotating the microphone boom around the headphone-microphone connection, the headphone-microphone connection is represented as a rotation center, the microphone boom is represented as a first vector, and a direction of the first vector represents a direction along which the microphone boom extends from the headphone-microphone connection. In the case where the microphone boom is located at the reference position, an angle between the first vector and a preset reference direction in the rotation plane is a reference angle. Before step 102, the foregoing microphone array calibration method further includes: determining a target angle between the first vector and the preset reference direction; in a case that a relationship between the target angle and the reference angle meets a preset deflection condition, determining that the position at which the microphone boom of the telephone headset is located is detected to be deflected relative to the pre-configured reference position.

During usage of the telephone headset, the microphone boom can be controlled to rotate around the headphone-microphone connection to change a position of the microphone boom. The pre-configured reference position may be a position at which the microphone boom is located when the angle between the first vector and the preset reference direction is the reference angle. The reference angle may be configured in advance. In a case where the headset body is worn over the tangible head model, an angle between the first vector representing the microphone boom and the preset reference direction when an extension direction of the microphone boom directs to the mouth of the tangible head model may serve as the reference angle. Alternatively, in a case where the headset body is worn over different human heads, angles between the first vector representing the microphone boom and the preset reference direction when the extension direction of the microphone boom directs to the mouths of different human heads are determined, and the angles are averaged to obtain the reference angle.

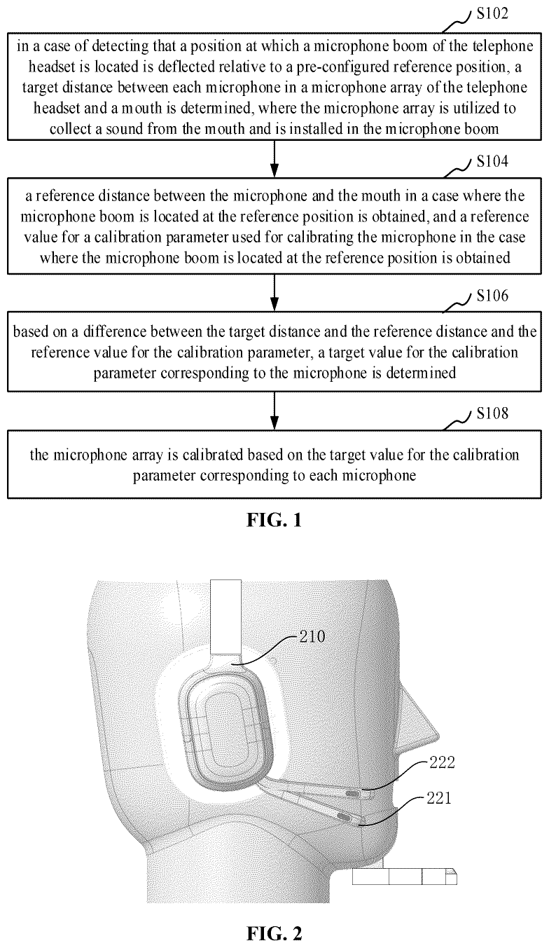

FIG. 2 is a schematic diagram of an example that the headset body is worn over a human head. As shown in FIG. 2, the headset body 210 is rotatably connected to the microphone boom. 221 and 222 may respectively indicate that the microphone boom is located at two different positions. 221 may indicate a position at which the microphone boom is located as mentioned in step 102, that is, a position at which the microphone boom is currently located. 222 may indicate a pre-configured reference position; and in this case, the extension direction of the microphone boom directs to the mouth.

The modulus of the first vector may be a length between the headphone-microphone connection and a terminal of the microphone boom that is away from the headphone-microphone connection along the extension direction. The preset reference direction may be a direction of a vertical axis in the earth coordinate system. Here, the direction of the vertical axis in the earth coordinate system may be specifically a positive direction of the vertical axis in the earth coordinate system. The preset reference direction may alternatively be a direction of a central axis of the human head wearing the headset body. The direction of the central axis of the human head may be specifically a direction of the central axis of the human head pointing from the jaw to the vertex. The preset deflection condition may be that the target angle is different from the reference angle, or may be that an angle difference between the target angle and the reference angle is greater than a preset angle difference. The preset angle difference is equal to, for example, 1 degree, 2 degrees, 3 degrees, or other degrees.

In the embodiment, the headphone-microphone connection is represented as the rotation center and the microphone boom is represented as the first vector, to determine the target angle between the first vector and the preset reference direction. By comparing the target angle with the reference angle in the case where the microphone boom is located at the reference position, it may be efficiently determined whether a position at which the microphone boom is located is deflected relative to the pre-configured reference position, which prepares for subsequent processes.

In an exemplary embodiment, the headset body is represented as a second vector in the rotation plane. A direction of the second vector represents a longitudinal direction of the headset body. The above-mentioned determining the target angle between the first vector and the preset reference direction may include: determining a first angle between the second vector and the preset reference direction, determining a second angle between the second vector and the first vector, and determining the target angle between the first vector and the preset reference direction according to the first angle and the second angle.

The longitudinal direction may be a direction of a central axis of the whole headset body. Specifically, the longitudinal direction may be a direction of the central axis of the whole headset body that points from a bottom of the headset body to a top of the headband. The longitudinal direction may alternatively be a direction of a central axis of the earbuff of the headset body. Specifically, the longitudinal direction may be a direction of the central axis of the earbuff pointing from one end of the earbuff close to the microphone boom to another end of the earbuff away from the microphone boom.

For example, an Inertial Measurement Unit (IMU) may be disposed in the headset body, and a sliding rheostat may be connected to the headphone-microphone connection. In the embodiment, the controller of the telephone headset may measure the first angle between the second vector and the preset reference direction by using the IMU, determine the second angle between the second vector and the first vector based on a value of the resistance of the sliding rheostat, and determine the target angle between the first vector and the preset reference direction according to the first angle and the second angle.

The IMU may determine an angle between the headset body and the preset reference direction, and may utilize a value of the determined angle as the first angle between the second vector and the preset reference direction. The headphone-microphone connection may change when the microphone boom rotates relative to the headset body; consequently, a value of the resistance of the sliding rheostat changes. Different values of the resistance of the sliding rheostat correspond to different preset angles. Therefore, by detecting a current value of the resistance of the sliding rheostat, a preset angle corresponding to the current value of the resistance may be determined, and the preset angle serves as the second angle between the second vector and the first vector. A difference obtained by subtracting the first angle from the second angle may be determined as the target angle between the first vector and the preset reference direction.

In the embodiment, the headset body is represented as the second vector in the rotation plane. By determining the first angle between the second vector representing the headset body and the preset reference direction and the second angle between the second vector and the first vector, the target angle between the first vector and the preset reference direction can be determined.

In an exemplary embodiment, different microphones in the microphone array are arranged linearly within the microphone boom along the extension direction. The different microphones are respectively represented as first position points in the first vector according to their respective positions within the microphone boom. The mouth is represented as a second position point in three-dimensional space. Step 102 of determining the target distance between each microphone and the mouth may include: determining, based on the target angle and a distance between the first position point representing the each microphone and the rotation center, a first relative position of the first position point representing the each microphone relative to the rotation center; obtaining a pre-configured second relative position of the second position point relative to the rotation center; and determining the target distance between the each microphone and the mouth based on the first relative position and the second relative position.

The linear arrangement may indicate that positions of different microphones within the microphone boom are located on one line. Different microphones are respectively represented as first position points in the first vector according to their respective positions within the microphone boom, so that a relative position of each microphone relative to the microphone boom is the same as a relative position of the first position point representing the each microphone relative to the first vector. Each first position point is located on a straight line determined by the first vector and is located between a start point of the first vector and an end point of the first vector.

The relative position of the microphone relative to the microphone boom may include a distance from the microphone to the headphone-microphone connection, and a distance from the microphone to the terminal of the microphone boom that is away from the headphone-microphone connection along the extension direction. The start point of the first vector may coincide with the rotation center representing the headphone-microphone connection. The relative position of the first position point relative to the first vector may include a distance from the first position point to the rotation center representing the headphone-microphone connection, and a distance from the first position point to the end point of the first vector. The end point may be a position point in the rotation plane, representing the terminal of the microphone boom that is away from the headphone-microphone connection along the extension direction.

The three-dimensional space is a space in which the coordinate system is located. The space in which the telephone headset is located may be a real-world three-dimensional space. The distance between the first position point representing each microphone and the rotation center may be the distance between the each microphone and the headphone-microphone connection. Distances between respective microphones and the headphone-microphone connection may be measured in advance, and measured values of the distances are stored in the telephone headset. The distances between different microphones and the headphone-microphone connection are distinct.

The first relative position may be coordinates of the first position point in a coordinate system that uses the rotation center as an origin. The coordinate system may be a three-dimensional rectangular coordinate system, a cylindrical coordinate system, a sphere coordinate system, or else. The preset reference direction may be a direction of a coordinate axis in the coordinate system. In this way, an angle between a line segment connecting the first position point representing the microphone to the rotation center and the preset reference direction may be the target angle. Since the distance between the first position point representing the microphone and the rotation center is pre-stored, the first relative position of the first position point representing the microphone relative to the rotation center can be determined.

The second relative position may be coordinates of the second position point in a coordinate system that uses the rotation center as an origin. The second relative position may be pre-configured, and may be configured with reference to a tangible head model wearing the headset body, or may be configured with reference to different human heads wearing the headset body. Specifically, in a case where the headset body is worn over the tangible head model, a coordinate system may be constructed by using the rotation center representing the headphone-microphone connection as an origin, a mouth of the tangible head model is represented as a position point in the coordinate system, and coordinates of the position point are configured as the second relative position. In a case where the headset body is worn over different human heads, a coordinate system may be constructed by using the rotation center representing the headphone-microphone connection as an origin, a mouth of each human head is represented as a position point in the coordinate system, and coordinates of position points in the coordinate system respectively representing mouths of different human heads are averaged, to obtain the second relative position.

In the embodiment, different microphones in the microphone array are linearly arranged within the microphone boom along the extension direction, and different microphones are respectively represented as first position points in the first vector according to their respective positions in the microphone boom. Therefore, the first relative position of the first position point representing each microphone relative to the rotation center can be determined based on the target angle and the distance between the first position point representing the each microphone and the rotation center. In addition, since both the first relative position representing the microphone and the second relative position representing the mouth are relative to the rotation center, the target distance between the microphone and the mouth can be determined, which prepares for subsequently determining the target value for the calibration parameter.

In an exemplary embodiment, in the three-dimensional space, a three-dimensional rectangular coordinate system is constructed with the rotation center as an origin. The preset reference direction is a direction of a vertical axis of the three-dimensional rectangular coordinate system. A horizontal axis of the three-dimensional rectangular coordinate system is located in the rotation plane and is perpendicular to the vertical axis. A perpendicular axis is perpendicular to the rotation plane. The first relative position is coordinates of the first position point representing the microphone in the three-dimensional rectangular coordinate system, and the second relative position is coordinates of the second position point in the three-dimensional rectangular coordinate system.

In the three-dimensional rectangular coordinate system, the vertical axis may be denoted as Z-axis, the horizontal axis may be denoted as X-axis, and the perpendicular axis may be denoted as Y-axis. The preset reference direction may be a direction of a vertical axis in the earth coordinate system, or may be a direction of a central axis of a human head wearing the headset body. In this way, the direction of the vertical axis in the three-dimensional rectangular coordinate system may be the direction of the vertical axis in the earth coordinate system, or may be the direction of the central axis of the human head wearing the headset body.

In the embodiment, the three-dimensional rectangular coordinate system is constructed by using the rotation center as the origin, the preset reference direction is the direction of the vertical axis in the three-dimensional rectangular coordinate system, and the horizontal axis is located in the rotation plane. In this way, the first relative position of the first position point representing the microphone relative to the rotation center can be quickly determined, so that the target distance between the microphone and the mouth can be quickly determined.

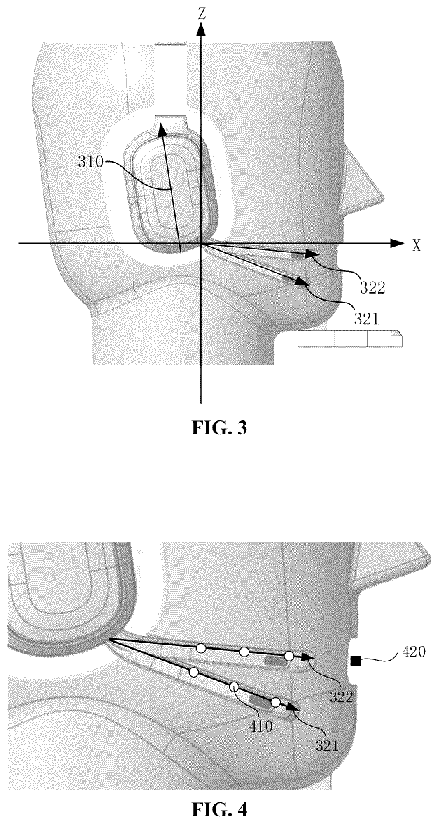

In an embodiment, on a condition that the foregoing three-dimensional rectangular coordinate system has been constructed by using the rotation center as the origin, reference may be made to FIG. 3, which is a schematic diagram exemplarily showing respective vectors when the headset body is worn over the human head. The preset reference direction may be the direction of the central axis of the human head wearing the headset body. In the three-dimensional rectangular coordinate system, the vertical axis may pass through the origin, and the direction of the vertical axis may be the same as the preset reference direction. As exemplarily shown in FIG. 3, the direction of the central axis of the human head is perpendicular to a horizontal plane. Therefore, the direction of the vertical axis is also perpendicular to the horizontal plane. In this way, an angle between the second vector 310 representing the headset body and Z-axis may be the first angle, and the first angle may be denoted as a. In a case where the microphone boom is located at a current position, an angle between the first vector 321 representing the microphone boom and the second vector 310 may be the second angle, and the second angle may be denoted as b; and an angle between the first vector 321 representing the microphone boom and Z-axis may be the target angle. In a case where the microphone boom is located at the reference position, an angle between the first vector 322 representing the microphone boom and Z axis may be the reference angle, and the reference angle may be denoted as c. An angle between the first vector 321 representing the microphone boom located at the current position and the first vector 322 representing the microphone boom located at the reference position may be denoted as d (also referred to as a deflection angle).

In an embodiment, reference may be made to FIG. 4, which is a schematic diagram showing various position points when the headset body is worn over the human head. A microphone array may be disposed within the microphone boom. The quantity of microphones in the microphone array may be equal to a positive integer greater than 2, for example, there may exist 3 microphones. Any microphone may be represented as a first position point 410 in the first vector. The mouth may be represented as a second position point 420 in the three-dimensional space.

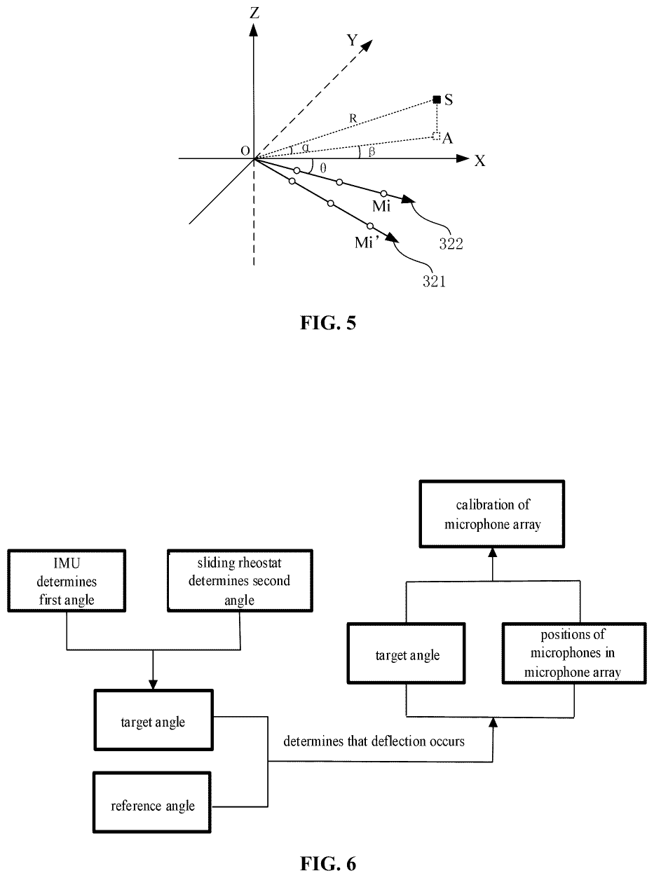

In an embodiment, reference may be made to FIG. 5, which is a schematic diagram exemplarily showing the first vector and respective position points in the three-dimensional rectangular coordinate system.

The rotation center representing the headphone-microphone connection serves as an origin of the three-dimensional rectangular coordinate system, which is denoted as point O. The rotation plane may be an XOZ plane formed by X-axis and Z-axis. In the three-dimensional rectangular coordinate system, the second position point 420 representing the mouth may be denoted as point S, any first position point in the first vector 322 representing the microphone boom located at the reference position may be denoted as point Mi, and any first position point in the first vector 321 representing the microphone boom located at the current position may be denoted as point Mi′. In FIG. 5, point S is located in a different Octant in the three-dimensional rectangular coordinate system from each of point Mi and point Mi′. It may be understood that, according to an actual situation, point S may be located in a same Octant in the three-dimensional rectangular coordinate system with point Mi and point Mi′.

Point S is projected onto the XOY plane formed by X-axis and Y-axis, and the projection is point A. The pre-configured second relative position of the second position point relative to the rotation center may be represented as follows: a relative distance from point S to point O is R, and relative azimuth angles of point S relative to point O are α and β. Here, α may be an angle between a line segment connecting point S to point O and the XOY plane, and β may be an angle between a line segment connecting the projection point A to point O and X-axis). Based on this, the second relative position may be represented in a manner of (x, z, y), and such manner is also utilized to represent coordinates or vectors hereinafter. The second relative position may be represented by coordinates of point S in the three-dimensional coordinate system, i.e., coordinates (R*cosα*cosβ, R*sinα, R*cosα*sinβ). Here, * indicates multiplication; cos indicates cosine function and cosα indicates cosine function performed on α; and sin indicates sine function and sinα indicates sine function performed on α. Meanings of cosβ, sinβ, and cosθ, Sinθ, cosθ′, and sinθ′ are similar, so they are not explained here.

The distance between the first position point representing any microphone and the rotation center is denoted as Li, that is, a distance between point Mi and point O is Li, and a distance between point Mi′ and point O is also Li. Here, i may represent a sequence number of the microphone. For example, the microphones in the microphone array may be sequentially marked with sequence numbers 1, 2, . . . , i from the terminal to which the microphone boom extends to the headphone-microphone connection.

An angle between the first vector 322 representing the microphone boom located at the reference position and X-axis is denoted as θ. θ may be equal to the reference angle c minus 90 degrees. The first relative position of point Mi relative to point O may be represented by coordinates (Li*cosθ, −Li*sinθ, 0) of point Mi in the three-dimensional coordinate system. Hence, a direction vector pointing from point S to point Mi is represented as (Li*cosθ−R*cosα*cosβ, −Li*sinθ−R*sinα, R*cosα*sinβ), and a modulus of the direction vector is calculated to obtain the reference distance.

An angle between the first vector 321 representing the microphone boom located at the current position and X-axis is denoted as θ′, where θ′=θ+d=c+d−90=b−a−90, d may represent the foregoing deflection angle, c may represent the reference angle, b may represent the second angle, a may represent the first angle, and the target angle may be obtained by b−a, i.e., subtracting the first angle from the second angle. The first relative position of point Mi′ relative to point O may be represented by coordinates (Li*cosθ′, −Li*sinθ′, 0) of point Mi′ in the three-dimensional coordinate system. Hence, a direction vector pointing from point S to point Mi′ is represented as (Li*cosθ′−R*cosα*cosβ, −Li*sinθ′−R*sinα, R*cosα*sinβ), and a modulus of the direction vector may be calculated to obtain the target distance. The target distance is denoted as SLi′, SLi′=√[Li\hat{ }2+R\hat{ }2+2*Li*R*(sinθ′*sinα−cosθ′*cosα*cosβ)], where √ may represent extraction of square root, Li\hat{ }2 may represent a square of Li, and R\hat{ }2 may represent a square of R.

In an exemplary embodiment, a calibration parameter includes a phase and a sensitivity, and a reference value for the calibration parameter includes a reference value for the phase and a reference value for the sensitivity. The process of determining, based on the difference between the target distance and the reference distance and the reference value for the calibration parameter, the target value for the calibration parameter corresponding to each microphone includes: determining a change amount of the phase based on the difference value between the target distance and the reference distance, a preset sound speed, and a sound frequency adapted to the telephone headset; performing a logarithmic operation based on the ratio of the target distance to the reference distance to determine a change amount of the sensitivity; and updating the reference value for the phase according to the change amount of the phase, and updating the reference value for the sensitivity according to the change amount of the sensitivity, to obtain the target value for the phase and the target value for the sensitivity, thereby determining the target value for the calibration parameter corresponding to each microphone.

The preset sound speed may be a speed of sound propagation in the air. The preset sound speed may be 340 m/s. The sound frequency is a frequency of vibration of the sound. The sound frequency adapted to the telephone headset may be set in advance for the telephone headset, for example, may be 130 Hz, 250 Hz, or else. Alternatively, in a case that the headset body is worn over the human head, a sound generated in an initial period after the mouth of the human head starts to generate sounds is collected, a frequency of the sound is obtained through calculation, and the obtained frequency of the sound is utilized as the sound frequency adapted to the telephone headset. The initial period may be a period of one second after the mouth starts to generate sounds.

For example, the controller of the telephone headset may determine the change amount of the phase according to a formula of ΔPh=(ΔSLi/C0)*f, and determine the change amount of the sensitivity according to a formula of ΔLevel=20*lg(SLi′/SLi), perform an addition operation on the change amount of the phase and the reference value for the phase to obtain the target value for the phase, and perform an addition operation on the change amount of the sensitivity and the reference value for the sensitivity to obtain the target value for the sensitivity.

ΔPh may represent the change amount of the phase, ΔSLi may represent the difference value between the target distance and the reference distance, C0 may represent the preset sound speed, f may represent the sound frequency adapted to the telephone headset, and/may represent a division operation. ΔLevel may represent the change amount of the sensitivity, SLi′ may represent the target distance, SLi may represent the reference distance, and lg may represent a logarithmic operation having 10 as the base.

In the embodiment, the change amount of the phase is calculated based on the difference value between the target distance and the reference distance, and the change amount of the sensitivity is calculated based on the ratio of the target distance to the reference distance, so that the reference value for the phase and the reference value for the sensitivity can be updated. The phase and the sensitivity of the microphone can change as the target distance changes, which prepares for accurate calibration of the microphone.

In a specific application scenario, a telephone headset includes a headset body and a microphone boom. The headset body and the microphone boom are rotatably connected at a position of a headphone-microphone connection. An IMU and a controller of the telephone headset may be disposed in the headset body. A sliding rheostat is connected to the headphone-microphone connection. A microphone array is installed in the microphone boom. In a rotation plane formed by rotating the microphone boom around the headphone-microphone connection, the headphone-microphone connection is represented as a rotation center. In the three-dimensional space, a three-dimensional rectangular coordinate system is constructed by using the rotation center as an origin, a preset reference direction is used as a direction of a vertical axis of the three-dimensional rectangular coordinate system, a horizontal axis of the three-dimensional rectangular coordinate system is located in the rotation plane and is perpendicular to the vertical axis, and a perpendicular axis is perpendicular to the rotation plane. In the three-dimensional rectangular coordinate system, the microphone boom is represented as a first vector, and the headset body is represented as a second vector. Different microphones are respectively represented as first position points in the first vector according to their respective positions within the microphone boom. The mouth is represented as a second position point in three-dimensional space. In a case where the microphone boom is located at a reference position, an angle between the first vector and the preset reference direction in the rotation plane is a reference angle. The foregoing microphone array calibration method may be performed in a case where the headset body of the telephone headset is worn over a human head. The microphone array of the telephone headset is utilized to collect a sound generated from the mouth of the human head. Referring to FIG. 6, which is a schematic flowchart of steps of microphone array calibration, the foregoing microphone array calibration method may specifically include the following steps.

The controller of the telephone headset may determine a first angle between the second vector and the preset reference direction by using the IMU in the headset body, determine a second angle between the second vector and the first vector by using the sliding rheostat connected to the headphone-microphone connection, and determine a target angle between the first vector and the preset reference direction according to the first angle and the second angle.

In a case where a relationship between the target angle and the reference angle meets a preset deflection condition, the controller of the telephone headset may determine, for each microphone in the microphone array that is in the telephone headset and is utilized to collect the sound generated from the mouth, coordinates of the first position point representing the each microphone in the three-dimensional rectangular coordinate system based on the target angle and a distance between the first position point representing the each microphone and the rotation center, to obtain a first relative position; obtain pre-configured coordinates of the second position point in the three-dimensional rectangular coordinate system, to obtain a second relative position; and determine a target distance between the each microphone and the mouth based on the first relative position and the second relative position.

The controller of the telephone headset may obtain a reference distance between each microphone and the mouth in a case where the microphone boom is located at the reference position, and may obtain a reference value for a phase and a reference value for a sensitivity that are utilized to calibrate the each microphone in the case where the microphone boom is located at the reference position.

The controller of the telephone headset may determine a change amount of the phase based on a difference value between the target distance and the reference distance, a preset sound speed, and a sound frequency adapted to the telephone headset; and perform a logarithmic operation based on a ratio of the target distance to the reference distance to determine a change amount of the sensitivity.

The controller of the telephone headset may update the reference value for the phase according to the change amount of the phase, and update the reference value for the sensitivity according to the change amount of the sensitivity, thereby obtaining a target value for the phase and a target value for the sensitivity.

The controller of the telephone headset may calibrate the microphone array based on the target value for the phase and the target value for the sensitivity that are corresponding to each microphone.

In a case where a position at which the microphone boom is located is deflected relative to the pre-configured reference position, in a conventional method, a microphone array generally collects a sound signal, and differences in sensitivity and phase among respective microphones of the microphone array in receiving the collected sound signal are determined, thereby re-calibrating the microphone array. The above method may have following problems. On one hand, the sound signal needs to be collected and sound signal processing calculation needs to be performed; consequently, a calibration process consumes a relatively long period of time, resulting in poor real-time performance. On the other hand, when there exists another sound source around, for example, another person talks around the person wearing the headset body, the logic of re-calibrating the microphone array in the conventional method may also be activated; hence, call noise reduction performance is “optimized” for the person talks around, while voice quality of the person wearing the headset body is degraded. Specifically, when there is another person talking around the person wearing the headset body, the voice volume of the person wearing the headset body is unstable, which affects call quality. In the above-described microphone array calibration method in the present application, in a case where a position at which the microphone boom is located is deflected relative to the pre-configured reference position, the microphone array does not need to collect a sound signal for achieving calibration, thereby avoiding problems in the conventional method.

It is understandable that although the individual steps in the flowcharts involved in the embodiments as described above are shown sequentially as indicated by the arrows, these steps are not necessarily executed sequentially in the order indicated by the arrows. Unless expressly stated herein, there is no strict order limitation on the execution of these steps, and these steps may be executed in other orders. Moreover, at least a portion of the steps in the flowchart involved in the embodiments as described above may include multiple sub-steps or multiple phases, which are not necessarily to be executed simultaneously, but may be executed at different time. In addition, the order in which these sub-steps or phases are executed is not necessarily sequential, but may be performed in turn or alternately with at least a portion of the other steps or at least a portion of the sub-steps or phases in the other steps.

Based on a same inventive concept, a microphone array calibration apparatus is further provided according to an embodiment of the present application, which may implement the above-described microphone array calibration method. The scheme for solving technical problem provided by the apparatus is similar to that recited in the above-mentioned method, so specific limitations in one or more embodiments directed to the microphone array calibration apparatus provided below can be referred to limitations for the above-mentioned microphone array calibration method, which are not repeated herein.

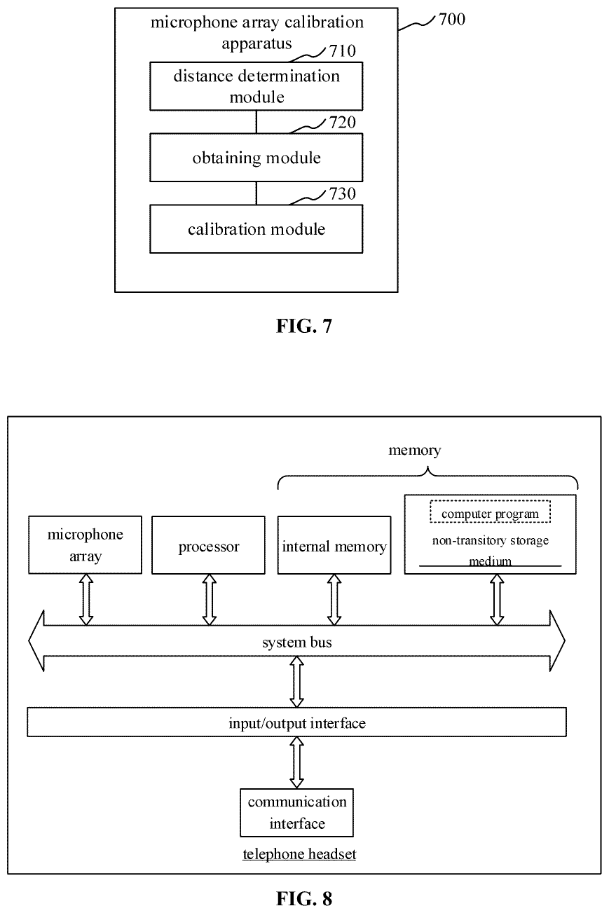

In an exemplary embodiment, as shown in FIG. 7, a microphone array calibration apparatus 700 is provided, including a distance determination module 710, an obtaining module 720, and a calibration module 730.

The distance determination module 710 is configured to: in a case of detecting that a position at which a microphone boom of a telephone headset is located is deflected relative to a pre-configured reference position, determine a target distance between each microphone in a microphone array of the telephone headset and a mouth, where the microphone array is utilized to collect a sound from the mouth and is installed in the microphone boom.

The obtaining module 720 is configured to: obtain a reference distance between each microphone and the mouth in a case where the microphone boom is located at the reference position, and obtain a reference value for a calibration parameter used for calibrating the each microphone in the case where the microphone boom is located at the reference position.

The calibration module 730 is configured to: determine, based on a difference between the target distance and the reference distance and the reference value for the calibration parameter, a target value for the calibration parameter corresponding to each microphone; and calibrate the microphone array based on the target value for the calibration parameter corresponding to the each microphone.

In an exemplary embodiment, the microphone boom is rotatably connected to the headset body of the telephone headset at a position of a headphone-microphone connection. In a rotation plane formed by rotating the microphone boom around the headphone-microphone connection, the headphone-microphone connection is represented as a rotation center, the microphone boom is represented as a first vector, and a direction of the first vector represents a direction along which the microphone boom extends from the headphone-microphone connection. In the case where the microphone boom is located at the reference position, an angle between the first vector and a preset reference direction in the rotation plane is a reference angle. The microphone array calibration apparatus 700 further includes an angle management module. The angle management module is configured to: determine a target angle between the first vector and the preset reference direction; in a case that a relationship between the target angle and the reference angle meets a preset deflection condition, determine that the position at which the microphone boom of the telephone headset is located is detected to be deflected relative to the pre-configured reference position.

In an exemplary embodiment, the headset body is represented as a second vector in the rotation plane. A direction of the second vector represents a longitudinal direction of the headset body. The angle management module is further configured to: determine a first angle between the second vector and the preset reference direction; determine a second angle between the second vector and the first vector; and determine the target angle between the first vector and the preset reference direction according to the first angle and the second angle.

In an exemplary embodiment, different microphones in the microphone array are arranged linearly within the microphone boom along an extension direction. The different microphones are respectively represented as first position points in the first vector according to their respective positions within the microphone boom. The mouth is represented as a second position point in three-dimensional space. The distance determination module 710 is further configured to: determine, based on the target angle and a distance between the first position point representing each microphone and the rotation center, a first relative position of the first position point representing the each microphone relative to the rotation center; obtain a pre-configured second relative position of the second position point relative to the rotation center; and determine the target distance between the each microphone and the mouth based on the first relative position and the second relative position.

In an exemplary embodiment, in a three-dimensional space, a three-dimensional rectangular coordinate system is constructed with the rotation center as an origin. The preset reference direction is a direction of a vertical axis of the three-dimensional rectangular coordinate system. A horizontal axis of the three-dimensional rectangular coordinate system is located in the rotation plane and is perpendicular to the vertical axis. A perpendicular axis is perpendicular to the rotation plane. The first relative position is coordinates of the first position point representing the microphone in the three-dimensional rectangular coordinate system, and the second relative position is coordinates of the second position point in the three-dimensional rectangular coordinate system.

In an exemplary embodiment, the calibration parameter includes a phase and a sensitivity, and the reference value for the calibration parameter includes a reference value for the phase and a reference value for the sensitivity. The calibration module 730 is further configured to: determine a change amount of the phase based on a difference value between the target distance and the reference distance, a preset sound speed, and a sound frequency adapted to the telephone headset; perform a logarithmic operation based on a ratio of the target distance to the reference distance to determine a change amount of the sensitivity; and update the reference value for the phase according to the change amount of the phase, and update the reference value for the sensitivity according to the change amount of the sensitivity, to obtain a target value for the phase and a target value for the sensitivity, so as to determine the target value for the calibration parameter corresponding to each microphone.

The various modules in the above-mentioned microphone array calibration apparatus may be realized in whole or in part by software, hardware, and combination thereof. Each of the above-mentioned modules may be embedded in or independent of a processor in the telephone headset in hardware form, or may be stored in a memory in the telephone headset in software form, so as to be invoked by the processor to perform an operation corresponding to each of the above-mentioned modules.

In an exemplary embodiment, a telephone headset is provided, including a headset body and a microphone boom. A diagram of an internal structure of the telephone headset may be shown in FIG. 8. The telephone headset includes a processor, a memory, an Input/Output (I/O for short) interface, and a communications interface that are disposed in the headset body, and a microphone array that is disposed in the microphone boom. The microphone array, the processor, the memory, and the I/O interface are connected via a system bus. The communication interface is connected to the system bus via the I/O interface. The microphone array of the telephone headset is configured to collect a sound. The processor of the telephone headset is configured to provide a computing and control capability. The memory of the telephone headset includes a non-transitory storage medium and an internal memory. The non-transitory storage medium stores an operating system, a computer program, and a database. The internal storage provides an environment for running the operating system and the computer program in the non-transitory storage medium. The I/O interface of the telephone headset is configured to exchange information between the processor and an external device. The communications interface of the telephone headset is configured to communicate with an external terminal via a network connection. The computer program, when executed by the processor, implements a microphone array calibration method.

It is understandable by those skilled in the art that the structure illustrated in FIG. 8, which is only a block diagram of a portion of the structure related to the solution of the present application, does not constitute a limitation of the telephone headset according to the present application. The specific telephone headset may include more or fewer components than shown in FIG. 8, or certain components can be combined, or may have a different arrangement of components.

According to an embodiment, a computer-readable storage medium is provided, having stored thereon a computer program. The computer program, when executed by a processor, cause the processor to implement the steps of the method according to any foregoing embodiment.

According to an embodiment, a computer program product is provided. The computer program product includes a computer program that, when executed by a processor, cause the processor to implement the steps of the method according to any foregoing embodiment.

It should be noted that user information (including but not limited to user equipment information, user personal information, and the like) and data (including but not limited to data used for analysis, stored data, and displayed data) involved in the present application are information and data that are authorized by a user or that are fully authorized by each party, and the collection, use, and processing of related data need to comply with related regulations.

A person of ordinary skill in the art may understand that all or part of the processes in the methods of the above embodiments can be accomplished by a computer program to instruct the relevant hardware, and the computer program may be stored in a non-transitory computer-readable storage medium. The computer program, when executed, may include processes of the respective methods according to the foregoing embodiments. The memory, database, or other medium used in the embodiments provided by this application may include at least one of a non-transitory memory and a transitory memory. The non-transitory memory may include Read-Only Memory (ROM), magnetic tape, floppy disk, flash memory, optical memory, high-density embedded non-transitory memory, Resistive Random Access Memory (ReRAM), Magnetoresistive Random Access Memory (MRAM), Ferroelectric Random Access Memory (FRAM), Phase Change Memory (PCM), Graphene Memory and so on. The transitory memory may include a Random Access Memory (RAM) or an external cache, and the like. As an illustration and not as a limitation, the RAM may be in various forms, such as Static Random Access Memory (SRAM) or Dynamic Random Access Memory (DRAM), and the like. The database involved in the embodiments provided in the present application may include at least one of a relational database and a non-relational database. The non-relational database may include a blockchain-based distributed database, etc., which is not limited herein. The processor involved in the embodiments provided in the present application may be a general-purpose processor, a central processing unit, a graphics processing unit, a digital signal processor, a programmable logic, a data processing logic based on quantum computing, an artificial intelligence (AI) processor, and the like, which is not limited herein.

The various technical features of the above embodiments may be combined arbitrarily. Possible combinations of the various technical features of the above embodiments are not enumerated for sake of conciseness. However, as long as there is no contradiction in the combinations of these technical features, they should be considered as falling within the scope of protection of the present application.

The above-described embodiments are merely several embodiments of the present application. These embodiments are described in a specific and detailed manner, but they shall not be construed as limitations to the scope of protection of the present application. It should be pointed out that for a person of ordinary skill in the art, various deformations and improvements can be made without departing from the concept of the present application, which all fall within the scope of protection of the present application. Therefore, the scope of protection of the present application shall be subject to the attached claims.

What is claimed is:

1. A microphone array calibration method, comprising:
in a case of detecting that a position at which a microphone boom of a telephone headset is located is deflected relative to a pre-configured reference position, determining a target distance between each microphone in a microphone array of the telephone headset and a mouth, wherein the microphone array is configured to collect a sound from the mouth and is installed in the microphone boom;
obtaining a reference distance between each microphone and the mouth in a case where the microphone boom is located at the reference position, and obtaining a reference value for a calibration parameter used for calibrating the each microphone in the case where the microphone boom is located at the reference position;
determining a target value for the calibration parameter corresponding to each microphone based on a difference between the target distance and the reference distance and the reference value for the calibration parameter; and
calibrating the microphone array based on the target value for the calibration parameter corresponding to the each microphone.

2. The microphone array calibration method according to claim 1, wherein the microphone boom is rotatably connected to a headset body of the telephone headset at a position of a headphone-microphone connection; in a rotation plane formed by rotating the microphone boom around the headphone-microphone connection, the headphone-microphone connection is represented as a rotation center, the microphone boom is represented as a first vector, and a direction of the first vector represents an extension direction along which the microphone boom extends from the headphone-microphone connection; in the case where the microphone boom is located at the reference position, an angle between the first vector and a preset reference direction in the rotation plane is a reference angle;
wherein the microphone array calibration method further comprises:
determining a target angle between the first vector and the preset reference direction; and
in a case that a relationship between the target angle and the reference angle meets a preset deflection condition, determining that the position at which the microphone boom of the telephone headset is located is detected to be deflected relative to the pre-configured reference position.

3. The microphone array calibration method according to claim 2, wherein the headset body is represented as a second vector in the rotation plane, and a direction of the second vector represents a longitudinal direction of the headset body;
wherein determining the target angle between the first vector and the preset reference direction comprises:
determining a first angle between the second vector and the preset reference direction;
determining a second angle between the second vector and the first vector; and
determining the target angle between the first vector and the preset reference direction according to the first angle and the second angle.

4. The microphone array calibration method according to claim 2, wherein different microphones in the microphone array are arranged linearly within the microphone boom along the extension direction, the different microphones are respectively represented as first position points in the first vector according to respective positions of the different microphones within the microphone boom, and the mouth is represented as a second position point in three-dimensional space;
wherein determining the target distance between each microphone and the mouth comprises:
determining, based on the target angle and a distance between the first position point representing the each microphone and the rotation center, a first relative position of the first position point representing the each microphone relative to the rotation center;
obtaining a pre-configured second relative position of the second position point relative to the rotation center; and
determining the target distance between the each microphone and the mouth based on the first relative position and the second relative position.

5. The microphone array calibration method according to claim 4, wherein in the three-dimensional space, a three-dimensional rectangular coordinate system is constructed with the rotation center as an origin; wherein the preset reference direction is a direction of a vertical axis of the three-dimensional rectangular coordinate system, a horizontal axis of the three-dimensional rectangular coordinate system is located in the rotation plane and is perpendicular to the vertical axis, and a perpendicular axis is perpendicular to the rotation plane; and wherein the first relative position is coordinates of the first position point representing the each microphone in the three-dimensional rectangular coordinate system, and the second relative position is coordinates of the second position point in the three-dimensional rectangular coordinate system.

6. The microphone array calibration method according to claim 1, wherein the calibration parameter comprises a phase and a sensitivity, and the reference value for the calibration parameter comprises a reference value for the phase and a reference value for the sensitivity;
wherein determining the target value for the calibration parameter corresponding to each microphone based on the difference between the target distance and the reference distance and the reference value for the calibration parameter comprises:
determining a change amount of the phase based on a difference value between the target distance and the reference distance, a preset sound speed, and a sound frequency adapted to the telephone headset;
performing a logarithmic operation based on a ratio of the target distance to the reference distance to determine a change amount of the sensitivity; and
updating the reference value for the phase according to the change amount of the phase and updating the reference value for the sensitivity according to the change amount of the sensitivity, to obtain a target value for the phase and a target value for the sensitivity, so as to determine the target value for the calibration parameter corresponding to each microphone.

7. A microphone array calibration apparatus, comprising a processor and a non-transitory memory which stores a computer program, wherein the processor, when executing the computer program, performs:
in a case of detecting that a position at which a microphone boom of a telephone headset is located is deflected relative to a pre-configured reference position, determining a target distance between each microphone in a microphone array of the telephone headset and a mouth, wherein the microphone array is configured to collect a sound from the mouth and is installed in the microphone boom;
obtaining a reference distance between each microphone and the mouth in a case where the microphone boom is located at the reference position, and obtaining a reference value for a calibration parameter used for calibrating the each microphone in the case where the microphone boom is located at the reference position; and
determining, based on a difference between the target distance and the reference distance and the reference value for the calibration parameter, a target value for the calibration parameter corresponding to each microphone; and calibrating the microphone array based on the target value for the calibration parameter corresponding to the each microphone.

8. A telephone headset, comprising a headset body and a microphone boom, further comprising a memory and a processor provided in the headset body, and a microphone array provided in the microphone boom, wherein the memory stores a computer program;
wherein the microphone array is configured to collect a sound, and the processor, when executing the computer program, performs steps of the microphone array calibration method according to claim 1.

9. A computer-readable storage medium, which stores a computer program thereon, wherein the computer program, when executed by a processor, cause the processor to implement steps of the microphone array calibration method according to claim 1.

10. A computer program product, comprising a computer program, wherein the computer program, when executed by a processor, cause the processor to implement steps of the microphone array calibration method according to claim 1.
